(19) United States
(12) Patent Application Publication
(10) Pub. No.: US 2007/0222918 A1
(43) Pub. Date: Sep. 27, 2007

(54) Backlight module

(75) Inventor: Meng-Ju Chuang, Hsinchu City (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/729,181

(22) Filed: Mar. 27, 2007

(30) Foreign Application Priority Data
Mar. 27, 2006 (TW) 095110542

(51) Int. Cl. G02F 1/1335; F21V 7/04

(52) U.S. Cl. 349/67; 362/609; 362/624; 362/293

(57) ABSTRACT

A backlight module comprises a light guide plate, a light source disposed on one lateral side of the light guide plate, a reflector disposed under the light guide plate, and a color layer of a predetermined color disposed under the reflector. Light from the light source is guided by the light guide plate. A part of the light penetrates the reflector and is reflected by the color layer to generate colored light which is mixed to the light from the light source to create light of desired color.

### BACKGROUND

The invention relates to a backlight module, and in particular to a backlight module comprising a color layer under the reflector to adjust the color temperature of emitted light.

A conventional backlight, shown in FIG. 1, comprises a light guide plate 10, a light source 20, a reflector 30 and a plurality of optical films 40. The light source 20 is disposed on one lateral side of the light guide plate 10. The reflector 30 is disposed under the light guide plate 20. The optical films 40 are disposed above the light guide plate 10. Light from the light source 20 is guided by the light guide plate 10 and reflected by the reflector 30 to penetrate the optical films 40. When applied to devices which require light of different color temperatures, such as device A requiring cold-blue light, or device B requiring warm-yellow light, however different light sources must be provided or manufactured, increasing costs and inconvenience.

### SUMMARY

An embodiment of a backlight module of the invention comprises a light guide plate, a light source disposed on one lateral side of the light guide plate, a reflector disposed under the light guide plate, and a color layer of a predetermined color disposed under the reflector. Light from the light source is guided by the light guide plate. A part of the light penetrates the reflector and is reflected by the color layer to generate colored light which is mixed with the light from the light source to create light of desired color.

The color layer can opaque and can be paper or PET.

In another embodiment, the color layer is formed on the back of the reflector by printing method or spraying method.

In another embodiment, the backlight module further comprises a housing disposed under the reflector. The color layer is formed on one side of the housing facing the reflector by printing method or spraying method.

### BRIEF DESCRIPTION OF THE DRAWINGS

The invention can be more fully understood by reading the subsequent detailed description and examples with references made to the accompanying drawings, wherein:

FIG. 1 is a schematic view of a conventional backlight module;

FIG. 2 is a schematic view of an embodiment of a backlight module of the invention;

FIG. 3 is an enlarged view of region A of FIG. 2;

FIG. 4 is a schematic view of another embodiment of a backlight module of the invention;

FIG. 5 is a schematic view of another embodiment of a backlight module of the invention;

FIG. 6 is a schematic view of a display module wherein a backlight module of the invention is applied; and

FIG. 7 is a schematic view of an electronic device wherein the display module of FIG. 6 is applied.

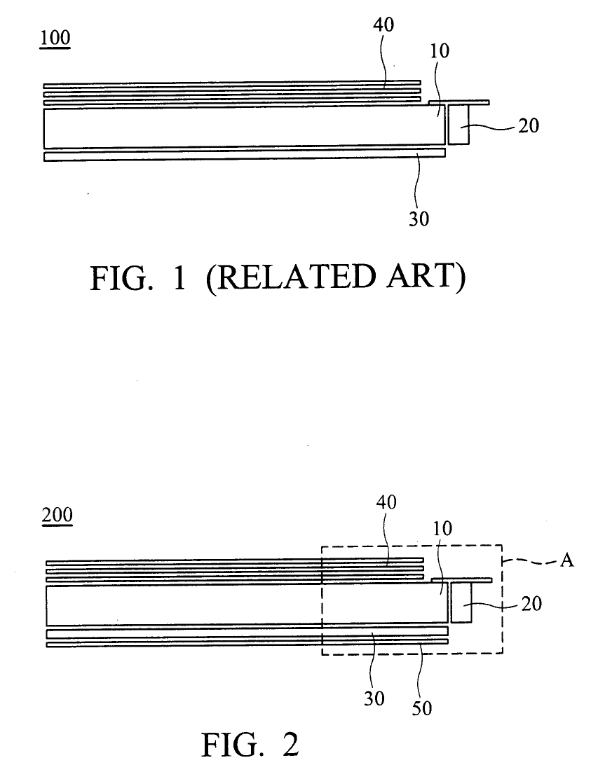

### DETAILED DESCRIPTION

Referring to FIGS. 2 and 3, the backlight module 200 comprises a light guide plate 10, a light source 20, a reflector 30, a plurality of optical films 40 and a color layer 50. The light source 20 is disposed on one lateral side of the light guide plate 10. The reflector 30 is disposed under the light guide plate 20. The optical films 40 are disposed above the light guide plate 10. The color layer 50 has a predetermined color and is disposed under the reflector 30.

As the reflector 30 is made of white PET, light from the light source 20 is guided by the light guide plate 20. Most of the light (90% to 95%) is reflected by the reflector 30 as shown by arrow a, but a part of the light (5% to 10%) penetrates the reflector 30 as shown by arrow b. Light b reaches the color layer 50 and is reflected by the color layer 50. The reflected light b is colored by the color layer 50. The colored light penetrates the reflector 30 and is mixed with the light a reflected by the reflector 30. In this way, light generated can be adjusted to desired color (color temperature).

The color layer 50 can be sufficiently opaque to prevent external environment light from influencing light color. The color layer 50 can be paper or PET. According to embodiments of the present invention, in order to provide different light colors to meet different customers' requirements, one can change the color layer 50, rather than the light source 20, which is more convenient.

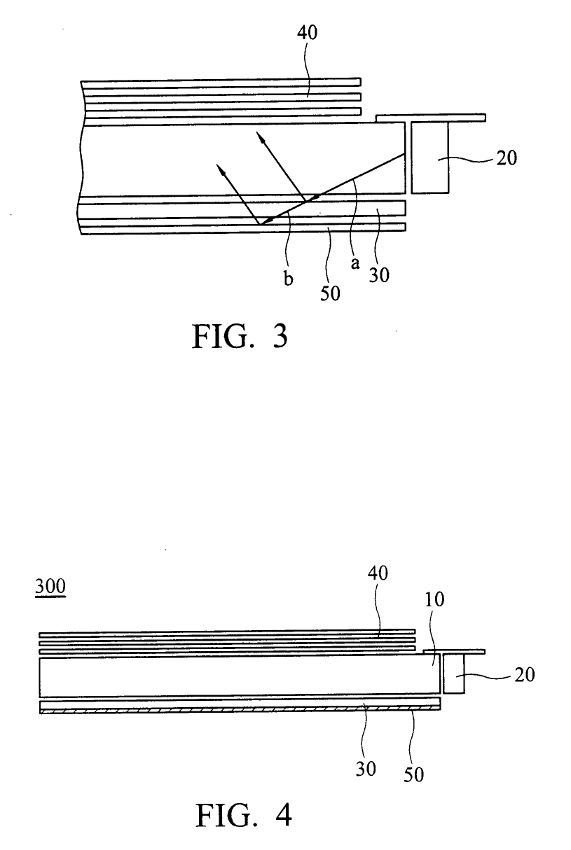

FIG. 4 depicts another embodiment of the backlight module. A backlight module 300 comprises a color layer 50 formed on the back of the reflector 30 by printing method or spraying method. Light penetrating the reflector 30 is reflected by the color layer 50, whereby light color temperature is adjusted. According to embodiments of the present invention, in order to provide different light colors to meet different customers' requirements, one can change the reflector 30, rather than the light source 20, which is more convenient.

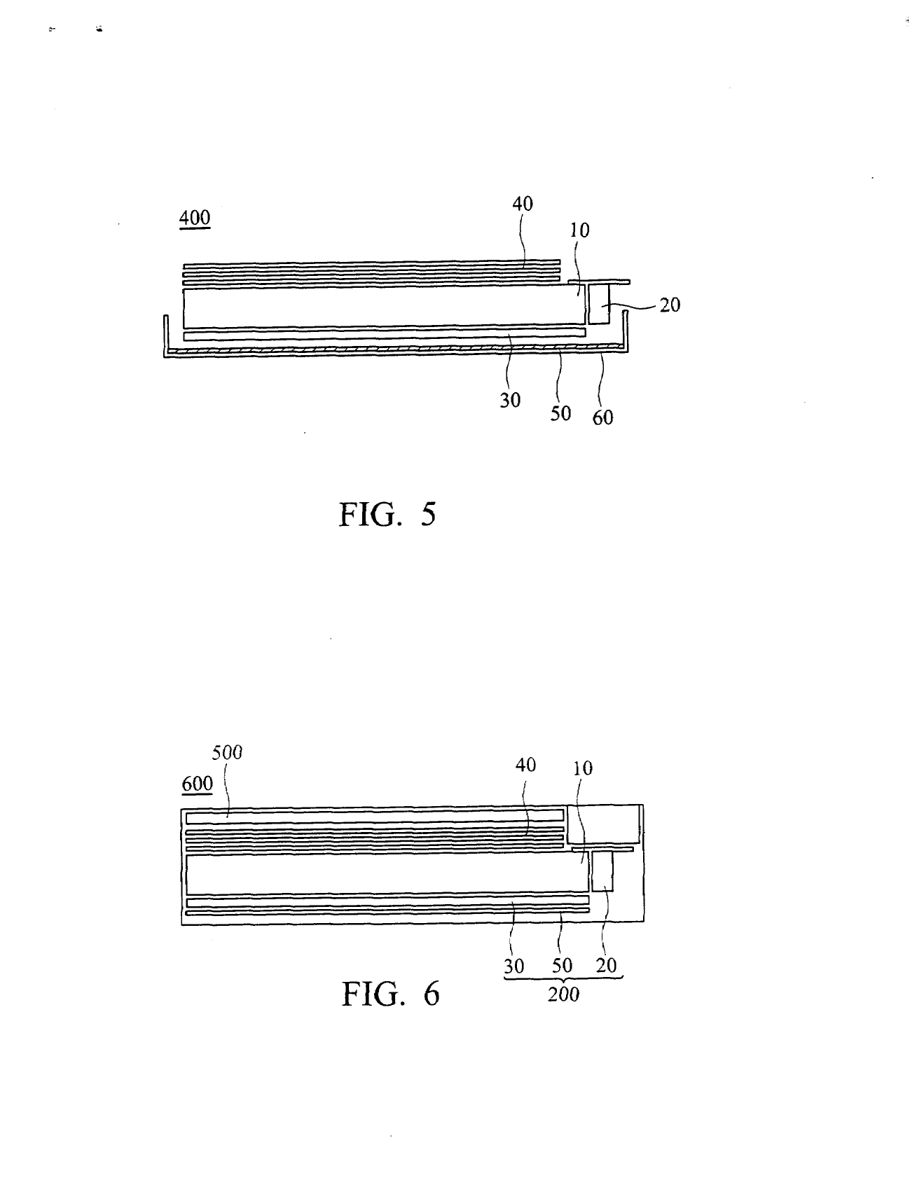

FIG. 5 depicts another embodiment of the backlight module. A backlight module 400 comprises a housing 60, with the color layer 50 formed on one side thereof facing the reflector 30 by printing method or spraying method. Light penetrating the reflector 30 is reflected by the color layer 50, whereby light color temperature is adjusted. According to embodiments of the present invention, in order to provide different light colors to meet different customers' requirements, one can change the housing 60, rather than the light source 20, which is more convenient.

Referring to FIG. 6, the backlight module 200 can be applied to a display module 600, wherein the backlight module 200 is joined to a panel 500.

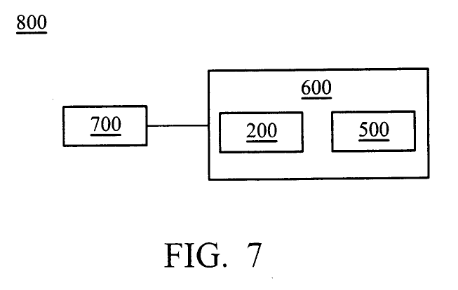

Referring to FIG. 7, the display module 600 can be applied to an electronic device 800, wherein the display module 600 is coupled to an input unit 700 which provides input signals to the display module 600.

The electronic device 800 can be a mobile phone, a digital camera, a personal digital assistant, a laptop, a desktop, a TV, a mobile display, or a portable DVD.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a light guide plate;
a light source disposed on one lateral side of the light guide plate;
a reflector disposed under the light guide plate; and
a color layer of a predetermined color disposed under the reflector, whereby the reflector is between the light guide plate and the color layer, light from the light source is guided by the light guide plate, and a part of the light penetrates the reflector and is reflected by the color layer to generate colored light which is mixed with the light from the light source to create light of desired color.

2. The backlight module as claimed in claim 1, wherein the color layer is opaque.

3. The backlight module as claimed in claim 2, wherein the color layer comprises paper.

4. The backlight module as claimed in claim 2, wherein the color comprises PET.

5. The backlight module as claimed in claim 1, wherein the color layer is formed on the back of the reflector.

6. The backlight module as claimed in claim 5, wherein the color layer is formed on the reflector by printing method.

7. The backlight module as claimed in claim 5, wherein the color layer is formed on the reflector by spraying method.

8. The backlight module as claimed in claim 1 further comprising a housing disposed under the reflector, wherein the color layer is formed on one side of the housing facing the reflector.

9. The backlight module as claimed in claim 8, wherein the color layer is formed on the housing by printing method.

10. The backlight module as claimed in claim 8, wherein the color layer is formed on the housing by spraying method.

11. The backlight module as claimed in claim 1, wherein the reflector comprises white PET.

12. A display module comprising:
a panel; and
a backlight module claimed as claim 1, wherein the backlight module is joined to the panel.

13. An electronic device comprising:
a display module claimed as claim 12; and
an input unit coupled and inputting signals to the display module.

14. The electronic device as claimed in claim 13, wherein the electronic device is a mobile phone, a digital camera, a personal digital assistant, a laptop, a desktop, a TV, a mobile display, or a portable DVD.
